(19) United States
(12) Patent Application Publication
(10) Pub. No.: US 2025/0272705 A1
(43) Pub. Date: Aug. 28, 2025

(54) E-COMMERCE BIG DATA ANALYSIS SYSTEM

(71) Applicant: XUHUI CAI, SINGAPORE (SG)

(72) Inventor: XUHUI CAI, SINGAPORE (SG)

(21) Appl. No.: 18/585,256

(22) Filed: Feb. 23, 2024

(51) Int. Cl. G06Q 30/0204; G06F 16/215

(52) U.S. Cl. CPC G06Q 30/0204; G06F 16/215

(57) ABSTRACT

The present disclosure relates to a technical field of E-commerce, and specifically discloses an E-commerce big data analysis system including a data collection module, a data storage module, a data sorting module and a data analysis module; wherein the data collection module is configured for collecting a real-time data; the data storage module is configured for receiving the real-time data and storing information generated by each module; the data sorting module is configured for converting the real-time data to a processed data and summarizing the processed data; and the data analysis module is configured for analyzing the processed data and outputs consumption results. The present disclosure can achieve precision marketing via acquiring basic real-time data information, establishing data models and a RFM (recency, frequency, monetary) model, and combining indicator and user tag analysis.

The present disclosure relates to a technical field of E-commerce, and in particular to an E-commerce big data analysis system.

### BACKGROUND

When consumer shops on an E-commerce platform, the E-commerce platforms will obtain important consumer behavior data, which can well evaluate the customer's value and needs. After consumers place an order, the E-commerce platform will correspondingly records consumption data including purchased products name, consumption time, product quantity and its price, etc. The consumption data are further configured for estimating a value of each consumer, thereafter personalized marketing plans for different consumer groups based on the value of each consumer will be provided.

Compared with conventional commerce industry, the E-commerce platform can optimize operation plans by digitally recording consumption data and analyzing consumer behavior. An E-commerce big data analysis system accurately delivers advertisements to customers based on their preferences. The E-commerce big data analysis system improves a marketing strategy based on big data analysis.

### SUMMARY

The present disclosure provides an E-commerce big data analysis system, aiming to solve the above technical problem.

The present disclosure provides following technical solutions:

An E-commerce big data analysis system includes a data collection module, wherein the data collection module is configured for collecting a real-time data; a data storage module, wherein the data storage module is configured for receiving the real-time data and storing information generated by each module; a data sorting module, wherein the data sorting module is configured for converting the real-time data to a processed data and summarizing the processed data; and a data analysis module, wherein the data analysis module is configured for analyzing the processed data and outputs consumption results.

Optionally, the data collection module obtains the real-time data from different services and simultaneously obtains a user behavior log data; the data collection module achieves incremental data collection via a binlog synchronization; and the data collection module completes real-time data collection, and the user behavior logs collection via a log collection system Flume.

Optionally, the Flume is a highly available and highly reliable distributed system for collecting and aggregating data resources such as logs or events. The design principle of the Flume is collecting and centrally storing data flow from web server to HDFS (Hadoop Distributed File System), HBASE, KAFKA, etc.; the features of the Flume are as follows:
1. The Flume can efficiently collect, transmit and store log data information from a large number of web servers;
2. The Flume supports various types of source input data and output data.
3. The Flume supports data transmission of various strategies and paths.
4. The Flume can be Horizontal Scaling.

Optionally, the data collection module collects a real-time data including user information, consumption information (details), product information, preferential information (activities), regional store information, and product category information. The user log data includes Web PC-side (Web Personal Computer) buried point information and Web APP-side (Web Application) buried point information.

Optionally, the data storage module includes a database with a hierarchical model structure as a data warehouse to store the real-time data; the data warehouse comprises an STG (stage) layer, an ODS (operational data store) layer, an ADS (analytical data store) layer and an DIM (dimension) layer; the data storage module establishes a real-time bidirectional data transmission channel with the data collection module, and the data analysis module.

Optionally, the data sorting module includes a data purification module and a data unification module. The data purification module is configured for eliminating duplicate data and useless data in the real-time data. The data unification module is configured for standardizing data form and setting default values for the real-time data. The data sorting module is configured for extracting and processing the real-time data stored in the data warehouse, and thereafter the processed data is restored in a corresponding position of the data warehouse.

Optionally, the data analysis module constructs an indicator system and business tags to analyze the processed data; the indicator system comprises overall sales indicators, sales indicators of each category, activity execution indicators, new user registration indicators, and business flow indicators; the business tags comprise user basic tags, user behavior tags, and user preference tags.

Optionally, the indicator system and business tags are as follows:

TABLE 1
New user registration indicator table

| | | | | | | | | |
|---|---|---|---|---|---|---|---|---|
| Date | Platform | Unregistered | Number | Registration | Number | New | Sales | Number of |
| | | Visitors | of new | conversion | of new | registered | generated | orders from |
| | | (UV) | registered | rate | registered | buyer | by new | new |
| | | | users | | buyers | conversion | registered | registered |
| | | | | | | rate | users | users |

TABLE 2
Business traffic indicator table

| | | | | | | | | |
|---|---|---|---|---|---|---|---|---|
| Date | Platform | Page | UV | Number | Proportion of | Regular | Per | Average |
| | | Views | | of new | new visitors | visitor | capita | stay time |
| | | (PV) | | visitors | | UV | visits | (seconds) |
| | | | | UV | | | (times) | |

TABLE 3
User base tag table

| Type | Indicator | Tag name |
|---|---|---|
| User base | Age | Under 18/18-24 years old/25-34 years old/35-44 years old/45-54 |
| tag | | years old/55+ |
| | Gender | Male/Female/Gender-Other |
| | Registration time | 1 day before/2 to 7 days before/8 to 30 days before/30 or more days |
| | | before |
| | Register terminal | Web/IOS/Android |
| | Number of historical | Register unpurchased users/1 single user/2 single users/multiple |
| | purchase orders | single users |

Optionally, the data analysis module establishes a data model for data analysis and configures an RFM (recency, frequency, monetary) model to analyze user behavior preferences; the data model is constructed based on business processes, stored data information and an E-R (Entity-Relationship) model in the business tags; the RFM model describes the user's value status through the user's recent consumption behavior information.

Optionally, the data analysis module analyzes the processed data and business tags through transformation, segmentation, and clustering based on the processed data and the data model, and sends the analysis results to the data storage module, The data analysis processing process are as follows:
1, Starting tasks to check whether it has latest data; if not, continue to wait; if there is latest data, load the latest data into an internal storage;
2, Determining current task conditions and whether it is necessary to correlate the latest data with the original data; if correlation is not required, directly analyzing the processed data; if correlation is required, analyzing the processed data after correlation of the tasks;
3, Sending analysis results of current task to the data storage module.

Compared with the prior art, the beneficial effects of the present disclosure are as follows.

The present disclosure obtains a real-time data and performs conversion processing, provides basic data information for analysis and processing of business conditions and analyze service conditions from two aspects in combination with indicator analysis and user tag analysis through constructing a data model and an RFM model, thereby improving data processing efficiency, better reflecting service operation conditions, performing accurate marketing for user features, and more effectively improving marketing efficiency.

### BRIEF DESCRIPTION OF DRAWINGS

FIG. 1 is a system framework diagram of the present disclosure.

FIG. 2 is an E-R schematic diagram of the RFM model of the present disclosure.

### DETAILED DESCRIPTION

Technical solutions in the embodiments of the present disclosure will be described clearly and completely in the following by referring to the accompanying drawings of the present disclosure. Apparently, the described embodiments are only a part of but not all the embodiments of the present disclosure. All other embodiments, which are obtained by any ordinary skilled person in the art based on the embodiments in the present disclosure without making creative work, shall fall within the protection scope of the present disclosure.

### Embodiments

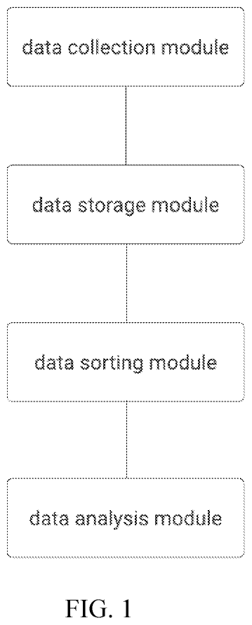

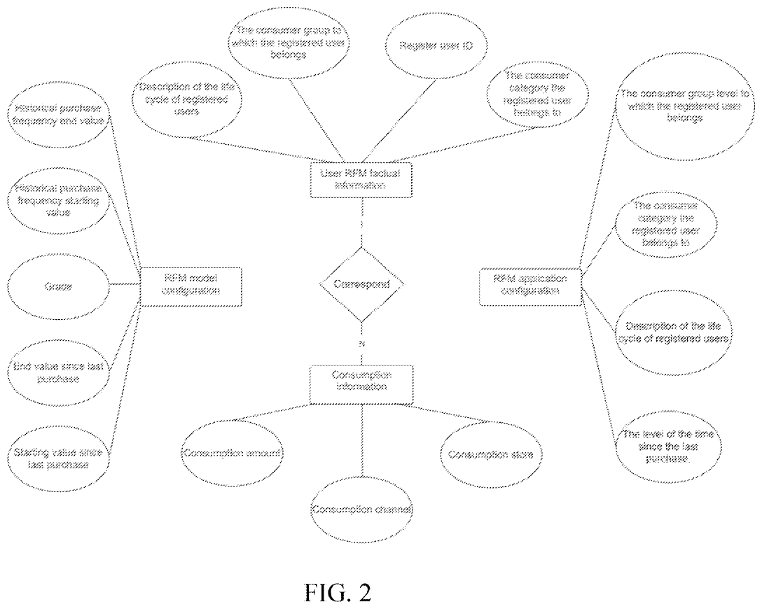

In the present embodiment, as shown in FIG. 1 and FIG. 2, an E-commerce big data analysis system includes a data collection module, a data storage module, a data sorting module, and a data analysis module. The data collection module is configured for collecting a real-time data; the data storage module is configured for receiving the real-time data and storing information generated by each module; the data sorting module is configured for converting the real-time data to a processed data and summarizing the processed data; and the data analysis module is configured for analyzing the processed data and outputs consumption results.

The data collection module obtains the real-time data from different services and simultaneously obtains a user behavior log data; the data collection module achieves incremental data collection via a binlog synchronization; and the data collection module completes real-time data collection, and the user behavior logs collection via a Flume.

The data storage module includes a database with a hierarchical model structure as a data warehouse to store the real-time data; the data warehouse includes an STG (stage) layer, an ODS (operational data store) layer, an ADS (analytical data store) layer and an DIM (dimension) layer, the data storage module establishes a real-time bidirectional data transmission channel with the data collection module, and the data analysis module.

The data sorting module includes a data purification module and a data unification module; the data purification module is configured for eliminating duplicate data and useless data in the real-time data; the data unification module is configured for standardizing data form and setting default values for the real-time data; and the data sorting module is configured for extracting and processing the real-time data stored in the data warehouse, and thereafter the processed data is restored in a corresponding position of the data warehouse.

The data analysis module constructs an indicator system and business tags to analyze the processed data; the indicator system comprises overall sales indicators, sales indicators of each category, activity execution indicators, new user registration indicators, and business flow indicators; the business tags comprise user basic tags, user behavior tags, and user preference tags.

The indicator system and business tags are as follows:

TABLE 1
New user registration indicator table

| | | | | | | | | |
|---|---|---|---|---|---|---|---|---|
| Date | Platform | Unregistered | Number of | Registration | Number | New | Sales | Number |
| | | Visitors | new | conversion | of new | registered | generated | of orders |
| | | (UV) | registered | rate | registered | buyer | by new | from new |
| | | | users | | buyers | conversion | registered | registered |
| | | | | | | rate | users | users |

TABLE 2
Business traffic indicator table

| | | | | | | | | |
|---|---|---|---|---|---|---|---|---|
| Date | Platform | Page | UV | Number | Proportion of | Regular | Per | Average |
| | | Views | | of new | new visitors | visitor | capita | stay time |
| | | (PV) | | visitors | | UV | visits | (seconds) |
| | | | | UV | | | (times) | |

TABLE 3
User base tag table

| Type | Indicator | Tag name |
|---|---|---|
| User base | Age | Under 18/18-24 years old/25-34 years old/35-44 years old/45-54 |
| tag | | years old/55+ |
| | Gender | Male/Female/Gender-Other |
| | Registration time | 1 day before/2 to 7 days before/8 to 30 days before/30 or more days |
| | | before |
| | Register terminal | Web/IOS/Android |
| | Number of historical | Register unpurchased users/1 single user/2 single users/multiple |
| | purchase orders | single users |

The data analysis module establishes a data model for data analysis and configures an RFM (recency, frequency, monetary) model to analyze user behavior preferences; the data model is constructed based on business processes, stored data information and an E-R (entity-relationship) model in the business tags; the RFM model describes the user's value status through the user's recent consumption behavior information.

The data analysis module analyzes the processed data and business tags through transformation, segmentation, and clustering based on the processed data and the data model, and sends the analysis results to the data storage module, The data analysis processing process are as follows:
1, Starting tasks to check whether it has latest data; if not, continue to wait; if there is latest data, load the latest data into an internal storage;
2, Determining current task conditions and whether it is necessary to correlate the latest data with the original data; if correlation is not required, directly analyzing the processed data; if correlation is required, analyzing the processed data after correlation of the tasks;
3, Sending analysis results of current task to the data storage module.

From the perspective of user consumption process, indicator analysis can be divided into the following links: Lead generation, Conversion, Consumption, Retention. In the Lead generation operation link, the quality of the website's incoming traffic can be measured through business traffic indicators. The purpose of Lead generation is to ensure the stability of the website's incoming traffic and try to improve the quality of the incoming traffic by adjusting the business flow indicators. In the conversion operation link, the conversion condition is known through the new registered user index, and the conversion rate of each link is improved. In the consumption operation link, the sales ranking, the key commodity proportion, and the platform proportion are known through the overall sales index and each category of sales indexes, and analysis is carried out from three aspects of personnel, commodities, and platforms. In the retention operation process, users are attracted through various channel activities. During sales activities, it is necessary to perform closed-loop analysis on sales activities in the early stage, the middle stage, and the later stage, including investment analysis and target prediction before activities, user participation, passenger flow analysis and sales order analysis in activities, target completion ratio after activity, cost sales ratio, etc.

As can be seen from the above, present disclosure obtains a real-time data and performs conversion processing, provides basic data information for analysis and processing of business conditions and analyze service conditions from two aspects in combination with indicator analysis and user tag analysis through constructing a data model and an RFM model, thereby improving data processing efficiency, better reflecting service operation conditions, performing accurate marketing for user features, and more effectively improving marketing efficiency.

Although the embodiments of the present disclosure have been shown and described, any ordinary skilled person in the art can perform various changes, modifications, substitutions, and variations on the embodiments without departing from the principles and spirit of the present disclosure. The scope of the present disclosure is limited by the appended claims and equivalents thereof.

We claim:

1. An E-commerce big data analysis system, comprising:
a data collection module, wherein the data collection module is configured for collecting a real-time data;
a data storage module, wherein the data storage module is configured for receiving the real-time data and storing information generated by each module;
a data sorting module, wherein the data sorting module is configured for converting the real-time data to a processed data and summarizing the processed data; and
a data analysis module, wherein the data analysis module is configured for analyzing the processed data and outputs consumption results.

2. The E-commerce big data analysis system according to claim 1, wherein the data collection module obtains the real-time data from different services and simultaneously obtains a user behavior log data; the data collection module achieves incremental data collection via a binlog synchronization; and the data collection module completes real-time data collection, and the user behavior logs collection via a Flume.

3. The E-commerce big data analysis system according to claim 1, wherein the data storage module comprises a database with a hierarchical model structure as a data warehouse to store the real-time data; the data warehouse comprises
an STG (stage) layer,
an ODS (operational data store) layer,
an ADS (analytical data store) layer and an DIM (dimension) layer,
the data storage module establishes a real-time bidirectional data transmission channel with the data collection module, and the data analysis module.

4. The E-commerce big data analysis system according to claim 3, wherein the data sorting module comprises a data purification module and a data unification module; the data purification module is configured for eliminating duplicate data and useless data in the real-time data; the data unification module is configured for standardizing data form and setting default values for the real-time data; and the data sorting module is configured for extracting and processing the real-time data stored in the data warehouse, and thereafter the processed data is restored in a corresponding position of the data warehouse.

5. The E-commerce big data analysis system according to claim 1, wherein the data analysis module constructs an indicator system and business tags to analyze the processed data; the indicator system comprises overall sales indicators, sales indicators of each category, activity execution indicators, new user registration indicators, and business flow indicators; the business tags comprise user basic tags, user behavior tags, and user preference tags.

6. The E-commerce big data analysis system according to claim 5, wherein the data analysis module establishes a data model for data analysis and configures an RFM (recency, frequency, monetary) model to analyze user behavior preferences; the data model is constructed based on business processes, stored data information and an E-R (Entity-Relationship) model in the business tags; the RFM model describes the user's value status through the user's recent consumption behavior information

7. The E-commerce big data analysis system according to claim 6, wherein the data analysis module analyzes the processed data and business tags through transformation, segmentation, and clustering based on the processed data and the data model, and sends the analysis results to the data storage module, The data analysis processing process are as follows:
starting tasks to check whether it has latest data; if not, continue to wait; if there is latest data, load the latest data into an internal storage;
determining current task conditions and whether it is necessary to correlate the latest data with the original data; if correlation is not required, directly analyzing the processed data; if correlation is required, analyzing the processed data after correlation of the tasks; and
sending analysis results of current task to the data storage module.
